(19) United States
(12) Patent Application Publication
(10) Pub. No.: US 2015/0125352 A1
(43) Pub. Date: May 7, 2015

(54) AIR PURIFICATION APPARATUS FOR VEHICLE

(71) Applicant: TOYOTA JIDOSHA KABUSHIKI KAISHA, Toyota-shi (JP)

(72) Inventor: Shigemasa HIROOKA, Susono-shi (JP)

(73) Assignee: TOYOTA JIDOSHA KABUSHIKI KAISHA, Toyota-shi (JP)

(21) Appl. No.: 14/527,993

(22) Filed: Oct. 30, 2014

(30) Foreign Application Priority Data
Nov. 1, 2013 (JP) 2013-228575

(51) Int. Cl. B01D 53/86

(52) U.S. Cl. CPC B01D 53/8675; B01D 2255/702; B01D 2255/2073
USPC 422/168

(57) ABSTRACT

An air purification apparatus for a vehicle, including a vehicle component provided at a location where air flows while the vehicle is moving, includes: an ozone decomposing body that contains MnO₂ and activated carbon as components that decompose ozone, the ozone decomposing body including a first layer and a second layer, the first layer being provided on a surface of the vehicle component, the content of MnO₂ being higher than that of activated carbon in the first layer, and the content of activated carbon being higher than that of MnO₂ in the second layer.

### INCORPORATION BY REFERENCE

The disclosure of Japanese Patent Application No. 2013-228575 filed on Nov. 1, 2013 including the specification, drawings and abstract is incorporated herein by reference in its entirety.

### BACKGROUND OF THE INVENTION

1. Field of the Invention

This invention relates to an air purification apparatus for a vehicle, and more specifically relates to an air purification apparatus for a vehicle by which ozone in air can be decomposed.

2. Description of Related Art

Ozone, which is a cause of photochemical smog, is produced by photochemical reactions between HC and NOx contained in exhaust gases from vehicles and factories. As a result, reducing the quantities of HC and NOx emitted by vehicles is effective means for suppressing the production of ozone and thereby preventing the occurrence of photochemical smog. However, directly decomposing ozone in air has been considered as means for preventing the occurrence of photochemical smog. Rather than attempting to reduce the emitted quantities of HC and NOx, which are reactants, it is possible to more effectively prevent the occurrence of photochemical smog by attempting to decompose ozone, which is a product of these reactants. With this in mind, vehicles equipped with air purification apparatuses for vehicles able to directly decompose ozone in air have been commercialized in some parts of the world, including California, United States. This type of air purification apparatus for vehicles is called direct ozone reduction (DOR).

Published Japanese Translation of PCT Application No. 2002-514966 (JP 2002-514966 A) discloses a DOR system in which a metal oxide such as MnO₂ is supported on a vehicle component such as a radiator. A radiator is disposed in a location that comes into contact with air while a vehicle is moving, and MnO₂ has the ability to decompose ozone contained in air by converting the ozone into other substances such as oxygen. Therefore, the DOR system disclosed in JP 2002-514966 A enables direct decomposing of ozone in air while a vehicle is moving. In addition, this document discloses an ozone decomposing test that uses activated carbon in addition to an ozone decomposing test that uses this metal oxide. In addition, this document indicates that activated carbon can catalyze a reaction in which ozone is reduced to O₂.

The Published Japanese Translation of PCT Application No. 10-512805 (JP 10-512805 A) discloses an ozone decomposing body obtained by combining a metal oxide such as MnO₂ with activated carbon. In this ozone decomposing body, however, activated carbon is used as an adsorbent for trapping pollutants contained in air.

The ability to decompose ozone is exhibited not only by metal oxides such as MnO₂, but also by activated carbon, as disclosed in JP 2002-514966 A. The ozone decomposing ability of activated carbon is equivalent to that of a metal oxide, and has the advantage of being able to decompose ozone in a low temperature range in which metal oxides are less active (approximately 25° C.). Therefore, by combining MnO₂ with activated carbon, ozone decomposing across a wide temperature range can be expected. However, there are differences between the ozone decomposing characteristics of MnO₂ and those of activated carbon. As a result, if MnO₂ and activated carbon are merely combined, the advantages of combining these components may not be realized.

### SUMMARY OF THE INVENTION

This invention is a DOR system that uses an ozone decomposing body obtained by combining MnO₂ with activated carbon, wherein the advantages of combining these components can be satisfactorily realized.

An air purification apparatus for a vehicle in one aspect of this invention includes a vehicle component provided at a location where air flows while the vehicle is moving, the air purification apparatus including: an ozone decomposing body that contains MnO₂ and activated carbon as components that decompose ozone, and the ozone decomposing body includes a first layer and a second layer, the first layer being provided on a surface of the vehicle component, the content of MnO₂ being higher than that of activated carbon in the first layer, and the content of activated carbon being higher than that of MnO₂ in the second layer.

In this aspect, the content of MnO₂ in the first layer may be between 50 wt % and 80 wt % inclusive, and the content of MnO₂ in the second layer may be equal to or higher than 20 wt % and lower than 50 wt %.

This aspect is characterized in that the vehicle component is at least one of a radiator, an intercooler, or an inverter for a hybrid vehicle.

According to this aspect of the invention, the content of MnO₂ can be set to be lower than the content of activated carbon in the second layer (the upper layer) and the content of MnO₂ can be set to be higher than the content of activated carbon in the first layer (the lower layer). The O₃ decomposing ability of MnO₂ deteriorates in cases where the temperature of MnO₂ is low or in cases where water is adsorbed on MnO₂. However, activated carbon can decompose O₃ in such cases. Therefore, the advantages of combining MnO₂ and activated carbon can be satisfactorily realized.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic view showing a configuration of a vehicle fitted with an air purification apparatus;

FIG. 2 is a cross-sectional schematic diagram of the core part of the radiator shown in FIG. 1;

FIG. 3 is a diagram showing differences in the differential pore volume of activated carbon before and after an endurance test;

FIG. 4 is a diagram showing changes over time in the ozone decomposing rate of activated carbon;

FIG. 5 is a diagram showing the relationship between the content of MnO₂ in ozone decomposing components that contain both activated carbon and MnO₂ and the ozone decomposing rate of these components;

FIG. 6 is a diagram showing the results of a chloride resistance test;

FIG. 7 is a diagram showing the results of a sulfur poisoning test;

FIGS. 8A to 8C show the results of water poisoning tests;

FIG. 9 is a diagram showing the relationship between the quantity of ozone decomposed and the content of MnO₂ in ozone decomposing components during the useful life of the apparatus;

FIGS. 10A to 10C are enlarged views of model particles on which H₂O is adsorbed;

FIGS. 11A and 11B show transitions in the number of adsorbed H₂O molecules, as calculated from the models shown in FIGS. 10A to 10C;

FIGS. 12A and 12B show transitions in the rate of coverage by H₂O molecules, as calculated from the models shown in FIGS. 10A to 10C;

FIGS. 13A to 13C are enlarged views of model particles in which O₃ is also adsorbed on the model particles on which H₂O is adsorbed;

FIGS. 14A and 14B show transitions in the number of adsorbed O₃ molecules, as calculated from the models shown in FIGS. 13A to 13C; and

FIGS. 15A and 15B show transitions in the rate of coverage by O₃ molecules, as calculated from the models shown in FIGS. 13A to 13C.

### DETAILED DESCRIPTION OF EMBODIMENTS

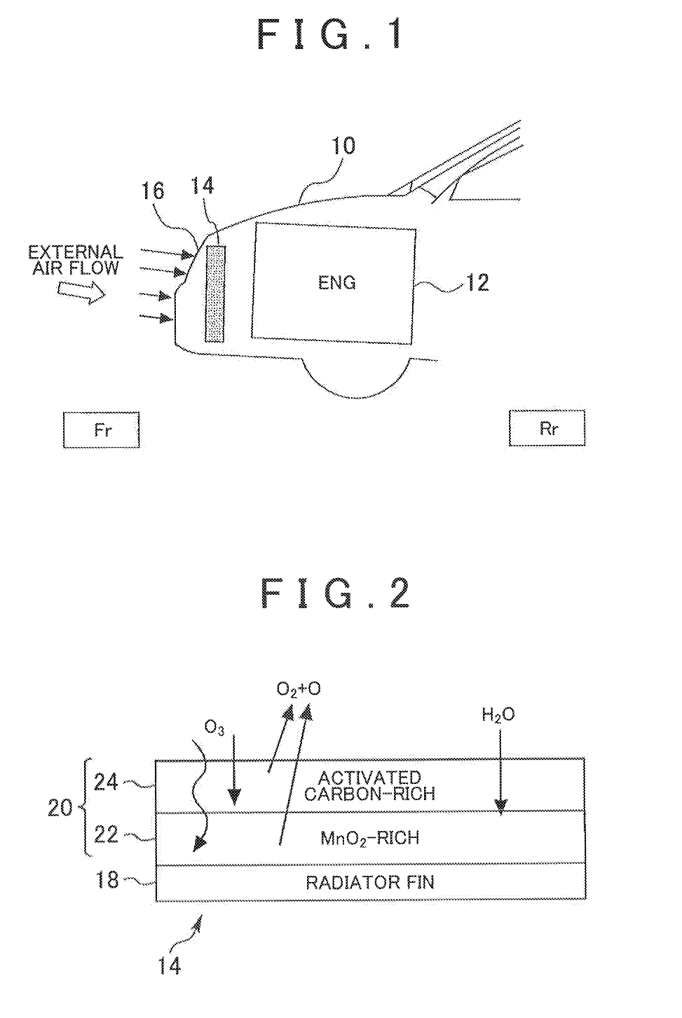

An embodiments of this invention will now be explained with reference to FIGS. 1 to 15B.

[Configuration of Air Purification Apparatus for Vehicle]

FIG. 1 is a schematic view showing a configuration of a vehicle fitted with the air purification apparatus of this embodiment. A vehicle 10 is provided with an internal combustion engine 12 as a power plant. Exhaust gases emitted from the internal combustion engine 12 contain HC and NOx. Ozone is produced by means of a photochemical reaction between the HC and NOx. In this way, the vehicle 10 provided with the internal combustion engine 12 is equipped with an air purification apparatus, and by decomposing ozone in air while the vehicle 10 is moving, it is possible to reduce the burden of the vehicle 10 on the environment.

In the vehicle 10, a radiator 14 that circulates cooling water within the internal combustion engine 12 is disposed in front of the internal combustion engine 12. As shown by the arrows in FIG. 1, air is drawn in through a bumper grille 16 on the front of the vehicle 10 while the vehicle 10 is moving, and the drawn in air passes through the radiator 14 and is discharged towards the internal combustion engine 12.

FIG. 2 is a cross-sectional schematic diagram of the core part of the radiator 14 shown in FIG. 1. As shown in FIG. 2, the core part of the radiator 14 is constituted from a radiator fin 18 and an ozone decomposing layer 20 formed on the radiator fin 18. The radiator fin 18 is constituted from an aluminum alloy having excellent thermal conductivity, or the like. The ozone decomposing layer 20 is constituted from an ozone decomposing body that contains MnO₂ and activated carbon as components that decompose ozone, and a binder that binds this ozone decomposing body to the radiator fin 18.

[Configuration of Ozone Decomposing Layer 20]

The ozone decomposing layer 20 is constituted from a MnO₂-rich layer 22, in which the blending proportion of MnO₂ in the ozone decomposing component is greater than that of activated carbon, and an activated carbon-rich layer 24, in which this blending proportion is lower than that of activated carbon. The content of MnO₂ in the ozone decomposing component contained in the MnO₂-rich layer 22 is preferably not lower than 50 wt % and not higher than 80 wt %. In addition, the content of MnO₂ in the ozone decomposing component contained in the activated carbon-rich layer 24 is preferably not lower than 20 wt % and lower than 50 wt %. By setting such contents, it is possible to decompose ozone in view of actual conditions in which vehicles move (hereinafter referred to as “real road conditions”) and the adsorption characteristics of the ozone decomposing body fitted to the vehicle. The basis for these ozone decomposing component contents will now be explained.

First, the reasons for using MnO₂ in combination with activated carbon will be explained while touching upon the ozone decomposing ability of activated carbon. Activated carbon has innumerable pores formed from the surface towards the inside. When ozone enters these pores (and especially mesopores and micropores having pore diameters of 10 nm or lower), the ozone is converted into CO, CO₂, O₂, and so on (C+O₃→CO, CO₂, O₂). The decomposing of the ozone by the activated carbon is attributable to this type of conversion reaction. However, the activated carbon is consumed as the ozone is decomposed, as can be seen from the reaction formula above.

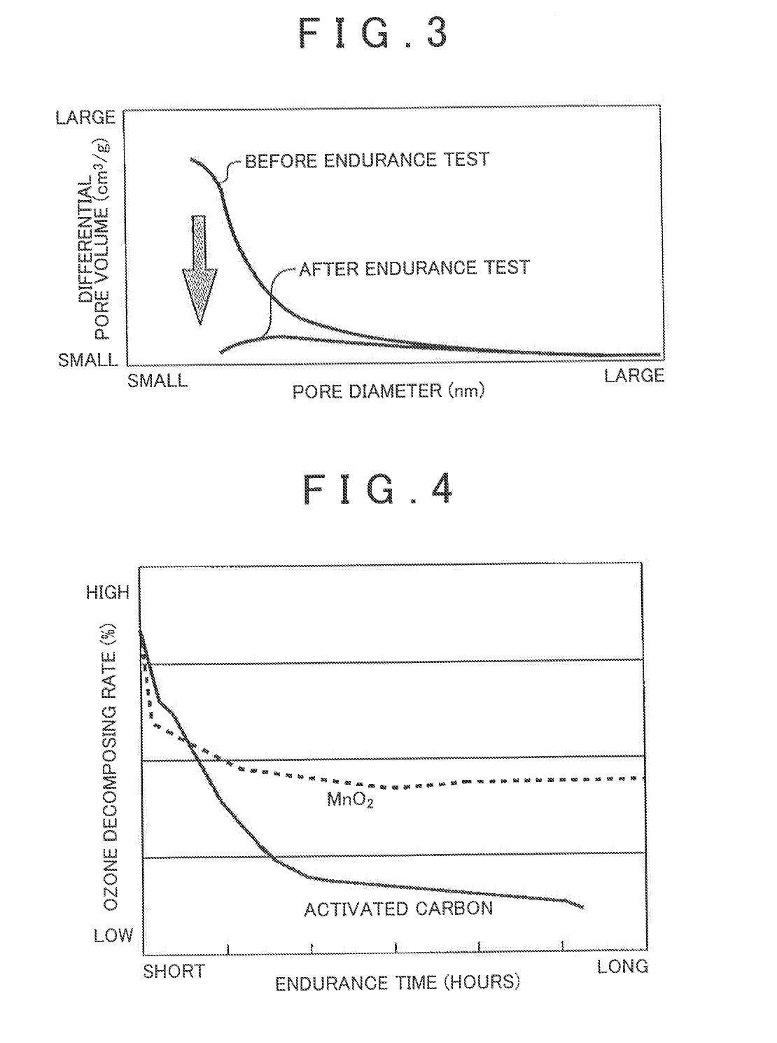

FIG. 3 is a diagram showing differences in the differential pore volume (cm³/g) of activated carbon before and after an endurance test. This endurance test is carried out by passing an ozone-containing gas having a fixed ozone concentration from the front to the rear of an activated carbon test piece. As can be seen from FIG. 3, the differential pore volume is significantly lower after the endurance test compared to before the endurance test. Because the differential pore volume indicates the abundance ratio of pores, a reduction in the differential pore volume means a reduction in this abundance ratio. These results are evidence for this consumption of activated carbon.

In addition, FIG. 4 is a diagram showing changes over time in the ozone decomposing rate (%) of the activated carbon. In the same way as in the endurance test mentioned in FIG. 3, the ozone decomposing rate mentioned in FIG. 4 is calculated by measuring the concentration of ozone at the front and rear of an activated carbon test piece when an ozone-containing gas is passed from the front to the rear of the test piece (ozone decomposing rate=ozone concentration at rear/ozone concentration at front).

In FIG. 4, the solid line represents the ozone decomposing rate of the activated carbon and the dotted line represents the ozone decomposing rate of the MnO₂. As can be seen from FIG. 4, the activated carbon exhibits an ozone decomposing rate that is similar to that of the MnO₂ in the initial stages. However, the ozone decomposing rate of the activated carbon decreases as the endurance time increases, and drops to approximately one quarter of the initial value after a long period of time has passed.

However, by focusing on the MnO₂, it can be understood that the ozone decomposing rate of the MnO₂ is high in the initial stages and is still approximately half of the initial value even after a long period of time has passed. In other words, it is understood that the MnO₂ exhibits excellent longevity of ozone decomposing ability compared to the activated carbon. This means that by using the MnO₂ together with the activated carbon, it is possible to make up for the decrease in the ozone decomposing ability of the activated carbon.

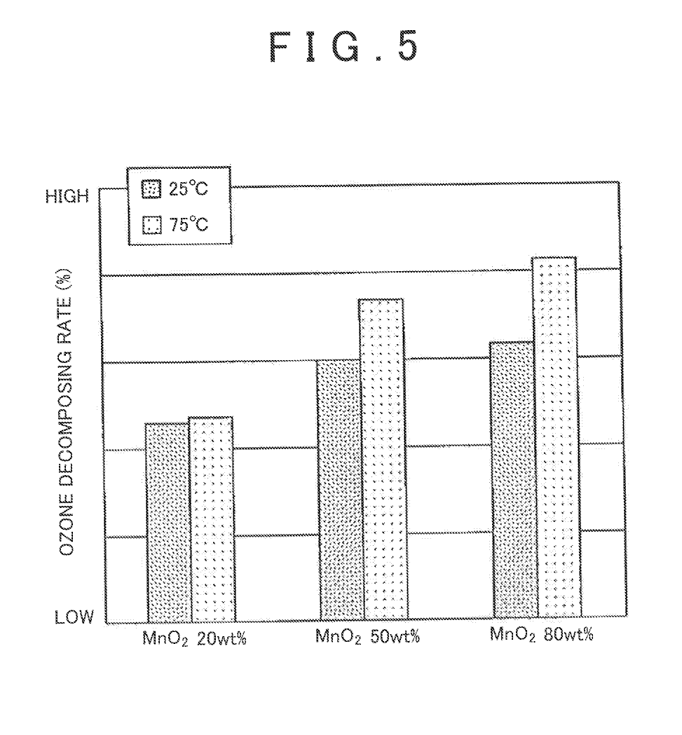

Next, an explanation will be given of the reason for setting the content of MnO₂ in the ozone decomposing components to be not lower than 20 wt % and not higher than 80 wt %. FIG. 5 is a diagram showing the relationship between the content (wt %) of MnO₂ in the ozone decomposing components that contains both activated carbon and MnO₂ and the ozone decomposing rate (%) of these components. The ozone decomposing rates shown in FIG. 5 are calculated by passing an ozone-containing gas across a test piece in which the content of MnO₂ in the ozone decomposing components is varied (that is, the blending ratio of the activated carbon and the MnO₂ is varied) using the same means as that used in the endurance test mentioned in FIG. 3 and measuring the ozone concentration at the front and rear of the test piece in the same way as mentioned in FIG. 4. Moreover, the temperature of the gas passed across the test piece was 25° C. and 75° C.

As can be seen from FIG. 5, a higher MnO₂ content leads to a higher ozone decomposing rate. In addition, in cases where the MnO₂ content was 50 wt % or 80 wt %, the ozone decomposing rate also varied according to the temperature of the gas passed across the test piece. The reason for this is due to the temperature characteristics of the MnO₂ ozone decomposing ability. That is, the ozone decomposing ability of MnO₂ picks up at a high temperature (approximately 80° C.), but gradually decreases at temperatures lower than this. However, if the content is 20 wt %, almost no changes are seen in the ozone decomposing rate. The reason for this is that the content of MnO₂ is low and there is little effect on the reduction in ozone decomposing rate.

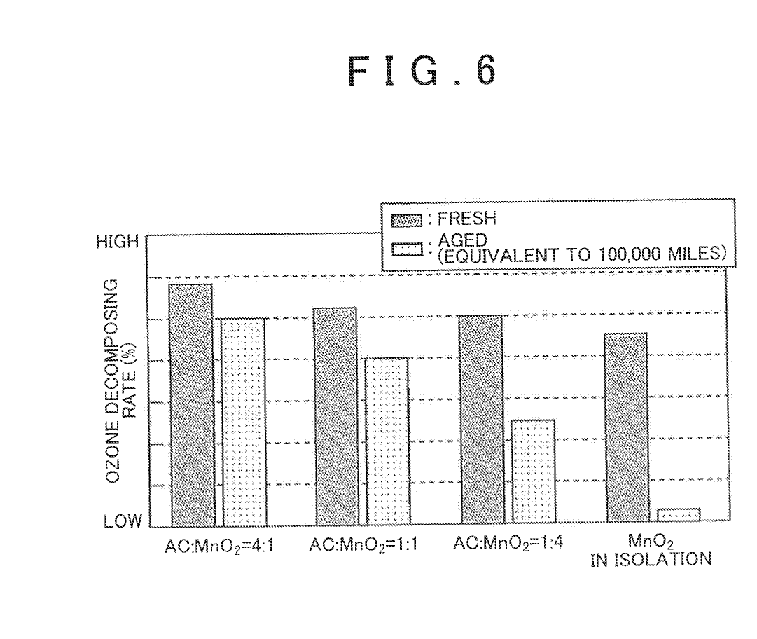

FIG. 6 is a diagram showing the results of a chloride resistance test. The reason for carrying out this test is to investigate the effects of snow melting agents (such as NaCl and CaCl₂) on road surfaces. Snow melting agents are scattered on road surfaces in order to prevent freezing, are dispersed into the air when churned up by preceding vehicles, and stick to the surface of the radiator of following vehicles. The chloride resistance test was carried out by temporarily immersing test pieces having varying MnO₂ contents in aqueous chloride solutions and then passing an ozone-containing gas over the test pieces using the same means as in the endurance test mentioned in FIG. 3. In addition, the ozone decomposing rate mentioned in FIG. 6 was calculated by measuring the ozone concentration at the front and rear of the test piece during the endurance test in the same way as mentioned in FIG. 4. Moreover, the temperature of the gas passed across the test piece was 25° C.

As can be seen from FIG. 6, the ozone decomposing rate following the endurance test (aged) was lower than in the initial state (fresh). In addition, this degree of reduction increases as the blending proportion of MnO₂ increases. In particular, when MnO₂ was used in isolation, the ozone decomposing rate following the endurance test was significantly lower than in the initial state. The reason for this is that the number of MnO₂ sites is reduced due to the adsorption of chlorides or due to detachment of the MnO₂ caused by precipitated chlorides. From the results shown in FIG. 6, it can be understood that in order to reduce the effect of snow melting agents, an MnO₂ content of 80 wt % or lower should be used.

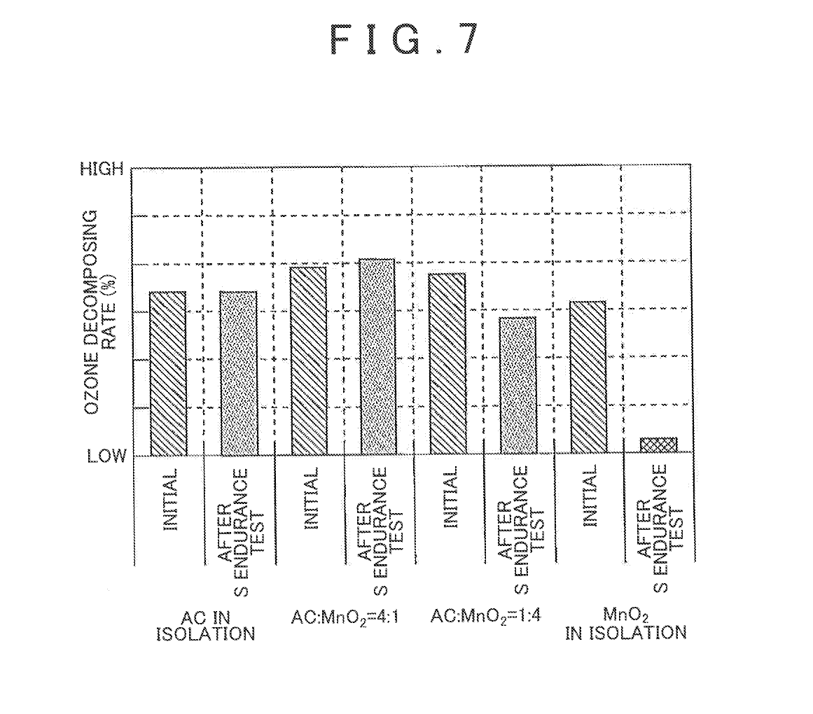

FIG. 7 is a diagram showing the results of a sulfur poisoning test. The reason for carrying out this test is to investigate the effects of SOx in air. SOx are sometimes emitted by vehicles and stick to the radiators of moving vehicles. The sulfur poisoning test was carried out by passing a gas that contains ozone and SO₂ across test pieces having varying MnO₂ contents. The ozone decomposing rate shown in FIG. 7 was calculated by measuring the ozone concentration at the front and rear of the test piece in during the endurance test the same way as mentioned in FIG. 4. Moreover, the temperature of the gas passed across the test piece was 25° C.

As can be seen from FIG. 7, in a case where the activated carbon (AC):MnO₂ ratio was 1:4, the ozone decomposing rate following the endurance test was lower than in the initial state. In particular, when MnO₂ was used in isolation, the ozone decomposing rate following the endurance test was significantly lower than in the initial state. However, when activated carbon was used in isolation, no difference in ozone decomposing rate was seen before and after the endurance test. At an AC:MnO₂ ratio of 4:1, the ozone decomposing rate following the endurance test was higher than in the initial state. From the results shown in FIG. 7, it can be understood that in order to reduce the effect of SO₂, a MnO₂ content of 80 wt % or lower is desirable and a MnO₂ content of 20 wt % is best.

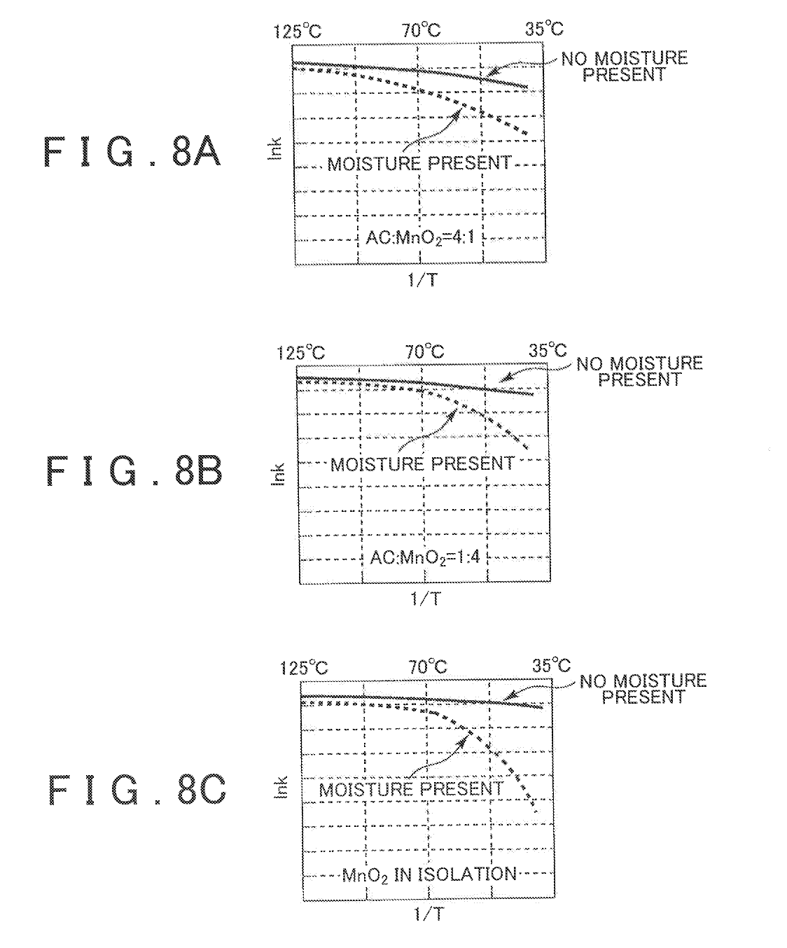

FIGS. 8A to 8C show the results of water poisoning tests. The reason for carrying out these tests is to investigate the effects of moisture in air. The water poisoning tests were carried out by passing a humidified gas (O₃ concentration: 100 ppm, O₂ concentration: 20%, H₂O concentration: 2%) and a dry gas (O₃ concentration: 100 ppm, O₂ concentration: 20%, H₂O concentration: 0%) across test pieces having varying MnO₂ contents.

FIGS. 8A to 8C each show an Arrhenius plot prepared on the basis of ozone decomposition rates calculated by measuring the concentration of ozone at the front and rear of a test piece while increasing the temperature of the test piece from 35° C. to 125° C. at a rate of temperature increase of 2.5° C./minute. As can be seen from FIGS. 8A to 8C, in cases where H₂O is present, a lower test piece temperature leads to a reduction in the reaction rate constant k (∝ decomposing rate). In addition, this reduction trend becomes more significant as the MnO₂ content increases. That is, if H₂O is present, the reactivity of the ozone decomposing body decreases. Moreover, in a high-temperature region of a test piece, a high value for the reaction rate constant k is due to the rate of evaporation of H₂O being high.

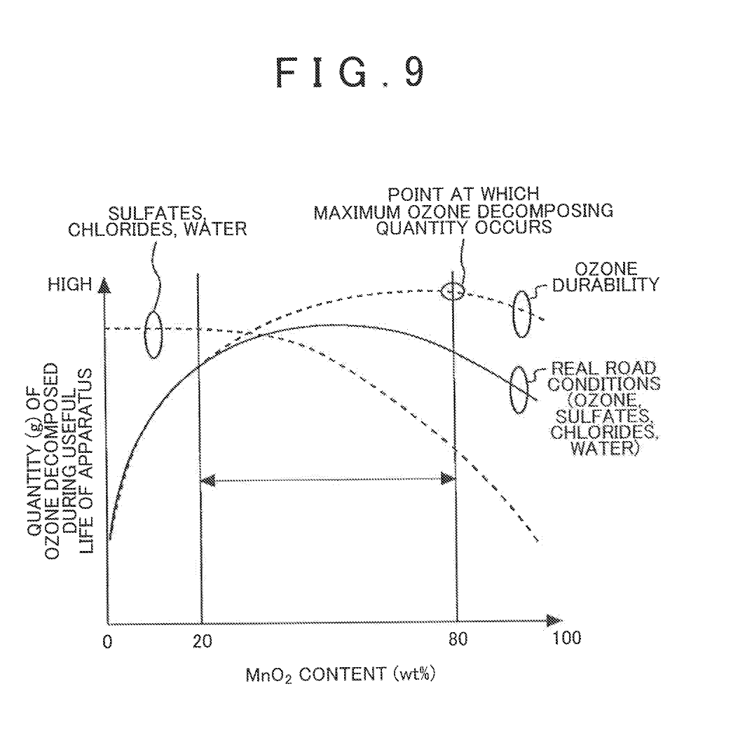

FIG. 9 is a diagram showing the relationship between the quantity (g) of ozone decomposed and the content (wt %) of MnO₂ in the ozone decomposing components during the useful life of the apparatus. In FIG. 9, the characteristic represented by “ozone durability” is based on the results shown in FIG. 5. That is, in order to obtain a high ozone decomposing quantity across the useful life of the apparatus, longevity of ozone decomposing ability is required. Therefore, it is essential to set the content of MnO₂ in the ozone decomposing component to be 20 wt % or higher. In addition, in FIG. 9, the characteristics represented by “sulfates, chlorides, water” are based on the results shown in FIGS. 6 to 8C. That is, in order to obtain a high ozone decomposing quantity across the useful life of the apparatus, it is essential to take into account the effects of real road conditions on the ozone decomposing ability. Therefore, it is not desirable to set the content of MnO₂ in the ozone decomposing components to be 80 wt % or higher. Taking all of these factors into account leads to the characteristics represented by the “real road conditions” shown in FIG. 9.

In recent years in particular, vehicles have become more fuel-efficient and one factor in this has been a tendency for the frequency with which water is supplied to the engine radiator to be reduced. In addition, in so-called hybrid vehicles, which are equipped with an internal combustion engine and an electric motor or an internal combustion engine and batteries, the burden on the internal combustion engine has been reduced and the frequency with which water is supplied to the engine radiator has been reduced. As a result, when supporting an ozone decomposing body on a radiator, it is desirable to consider such water supply conditions in advance. In this respect, the content of MnO₂ in the ozone decomposing components is adjusted on the basis of the endurance test results at a passing gas temperature of 25° C. in the ozone decomposing body of this embodiment. Therefore, even in cases where operating conditions under which the frequency with which water is supplied to the radiator is reduced occur continuously, it is possible to achieve obtain a high ozone decomposing quantity across the useful life of the apparatus.

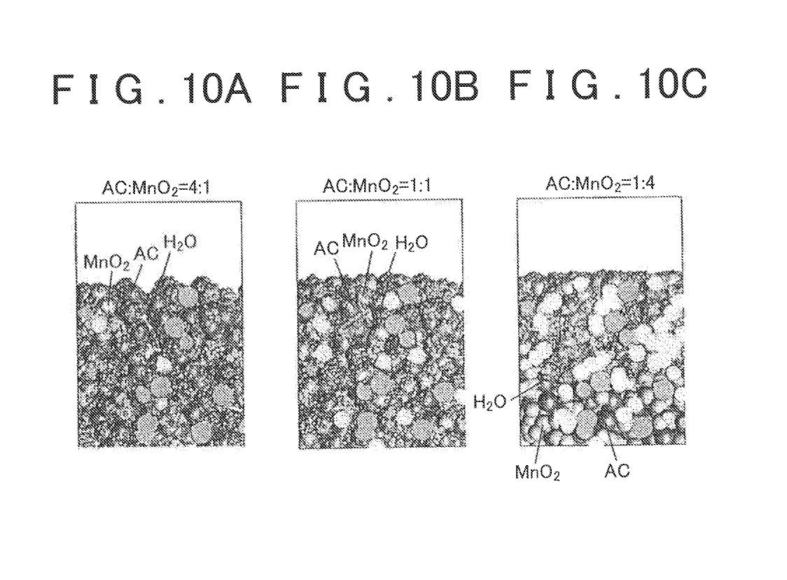

Finally, an explanation will be given for the reasons for setting the content of MnO₂ in the MnO₂-rich layer 22 and that in the activated carbon-rich layer 24 to fall within the ranges mentioned above. FIGS. 10A to 15B are diagrams showing the results of adsorption calculations. The reason for carrying out adsorption calculations is to confirm the adsorption behavior of O₃ molecules and H₂O molecules. These calculations were carried out using a porosity simulator. With the porosity simulator, the specific surface area and average pore diameter of actually prepared ozone decomposing bodies are measured, and porous model particles are prepared in such a way as to match these ozone decomposing bodies. Next, the quantity adsorbed per prepared model particle is determined. When determining the quantity adsorbed, consideration is given to the quantity adsorbed under preset conditions calculated using a Grand Canonical Monte Carlo calculation program. Next, the determined quantity adsorbed per particle is expanded up to the scale of a model (1 cell). In addition, the quantity adsorbed on an actual measurement scale is determined from the size of this model and the quantity adsorbed per model.

FIGS. 10A to 10C are enlarged views of model particles on which H₂O is adsorbed. In FIGS. 10A to 10C, H₂O is allowed to flow onto the model particles downwards from above. Of the plurality of particles shown in FIG. 10, those having extremely small particle diameters are H₂O. As can be seen from FIGS. 10A and 10B, H₂O is adsorbed uniformly on activated carbon particles and MnO₂ particles in the model. In FIG. 10C, however, much of the H₂O is adsorbed at sites in the upper half of the model, but not in the lower half. Therefore, in cases where the AC:MnO₂ ratio is 1:4, the distribution of H₂O is not even.

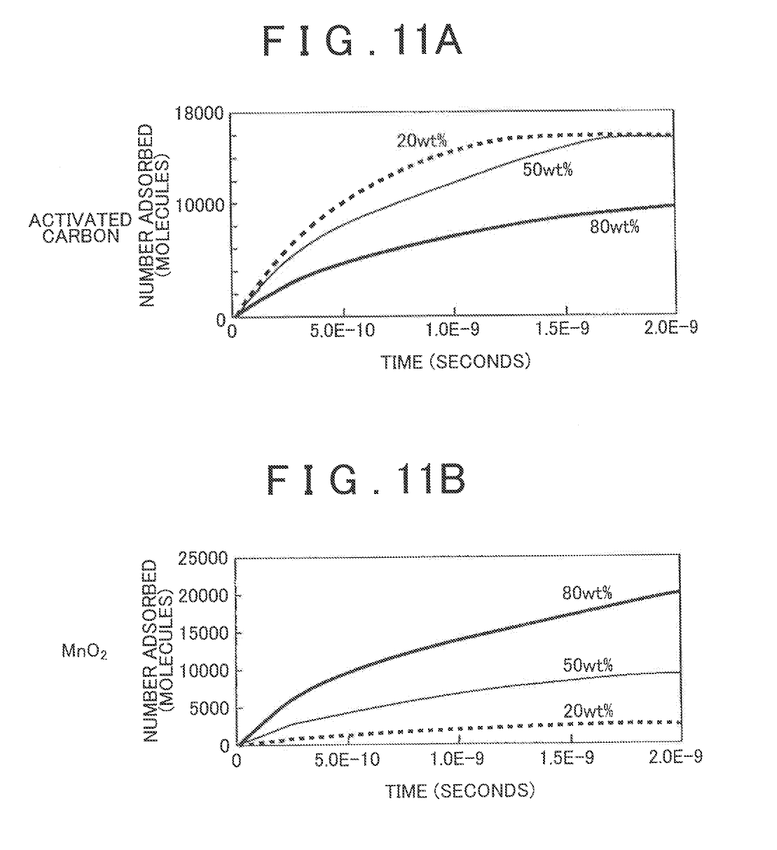

FIGS. 11A and 11B show transitions in the number of adsorbed H₂O molecules, as calculated from the models shown in FIGS. 10A to 10C. FIG. 11A shows the number of H₂O molecules adsorbed on the activated carbon, and FIG. 11B shows the number of H₂O molecules adsorbed on the MnO₂. Moreover, the line graphs shown in FIGS. 11A and 11B were prepared for each MnO₂ content. As can be seen from FIGS. 11A and 11B, the number of adsorbed H₂O molecules increases as time passes. In addition, if the numerical values at a content of 50 wt % are compared, more H₂O molecules are adsorbed by the activated carbon than by the MnO₂. In addition, as the content of MnO₂ increases, the number of HzO molecules adsorbed by the activated carbon decreases and the number of H₂O molecules adsorbed by the MnO₂ increases.

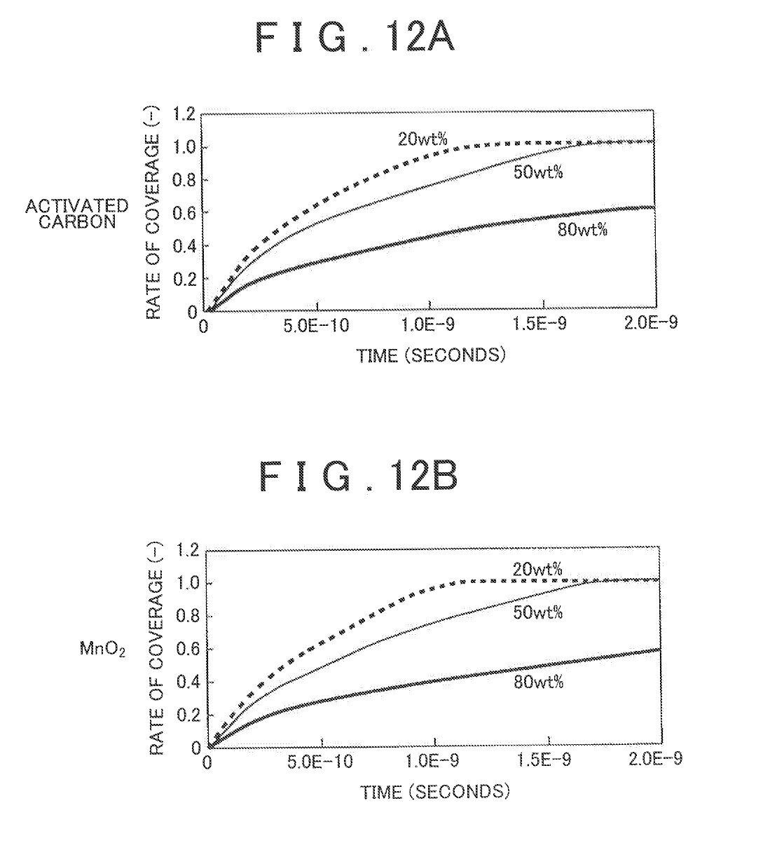

FIGS. 12A and 12B show transitions in the rate of coverage by H₂O molecules, as calculated from the models shown in FIGS. 10A to 10C. The results shown in FIG. 12A correspond to the results shown in FIG. 11A, and the results shown in FIG. 12B correspond to the results shown in FIG. 11B. As can be seen from FIGS. 12A and 12B, in cases where the content of MnO₂ is 20 wt % or 50 wt %, the rate of coverage of both the activated carbon and the MnO₂ approaches 1.0 as time passes. However, in cases where the content of MnO₂ is 80 wt %, the rate of coverage of both the activated carbon and the MnO₂ is low. This is because the distribution of H₂O molecules in the model is uneven, as shown in FIG. 10C.

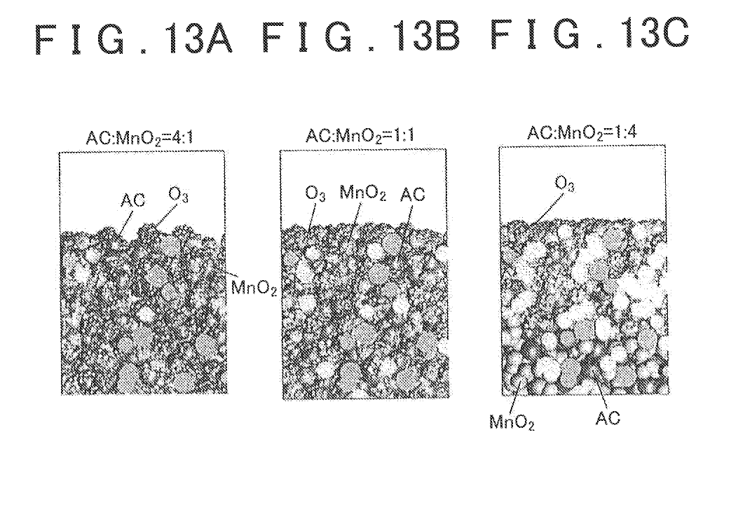

FIGS. 13A to 13C are enlarged views of model particles in which O₃ is also adsorbed on the model particles on which H₂O is adsorbed (that is, the model particles shown in FIGS. 10A to 10C). In FIGS. 13A to 13C, H₂O and O₃ are allowed to flow onto the model particles downwards from above. Of the plurality of particles shown in FIGS. 13A to 13C, those having extremely small particle diameters are O₃. Moreover, H₂O is omitted in FIGS. 13A to 13C. As can be seen from FIGS. 13A and 13B, O₃ is adsorbed uniformly on activated carbon particles and MnO₂ particles in the model. In FIG. 13C, however, much of the O₃ is adsorbed at sites in the upper half of the model, but not in the lower half. Therefore, in cases where the AC:MnO₂ ratio is 1:4, the distribution of O₃ is not even.

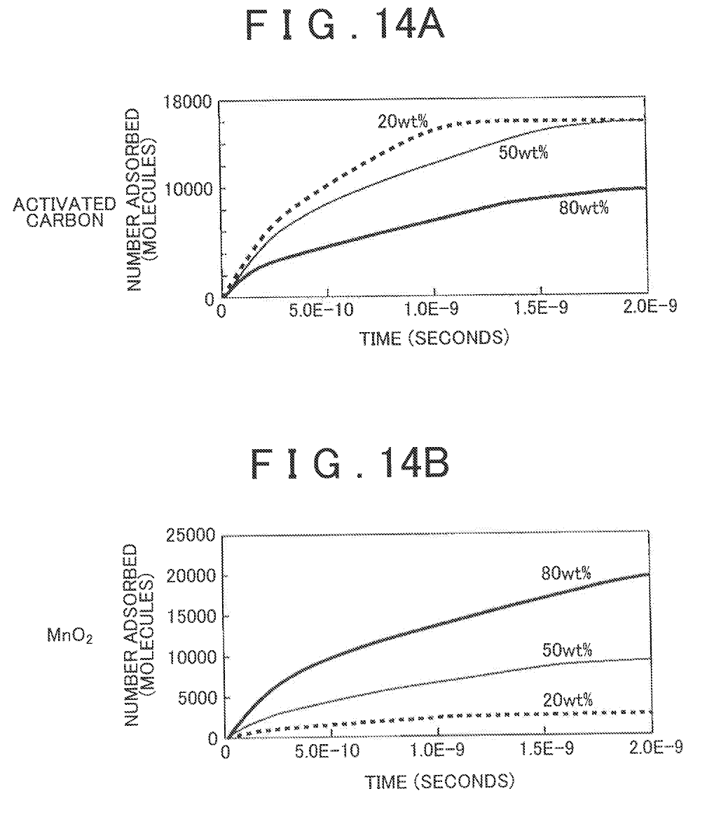

FIGS. 14A and 14B show transitions in the number of adsorbed O₃ molecules, as calculated from the models shown in FIGS. 13A to 13C. FIG. 14A shows the number of O₃ molecules adsorbed on the activated carbon, and FIG. 14B shows the number of O₃ molecules adsorbed on the MnO₂. Moreover, the line graphs shown in FIGS. 14A and 14B were prepared for each MnO₂ content. As can be seen from FIGS. 14A and 14B, the transitions in the number of adsorbed O₃ molecules show similar tendencies to the H₂O transitions explained in FIGS. 11A and 11B.

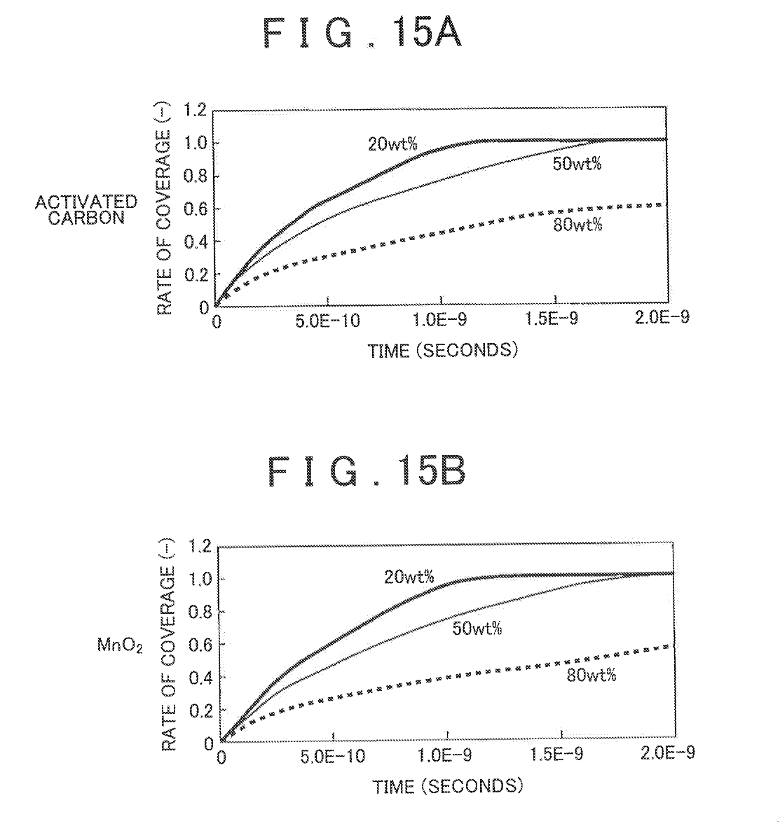

FIGS. 15A and 15B show transitions in the rate of coverage by O₃ molecules, as calculated from the models shown in FIGS. 13A to 13C. The results shown in FIG. 15A correspond to the results shown in FIG. 14A, and the results shown in FIG. 15B correspond to the results shown in FIG. 14B. As can be seen from FIGS. 15A and 15B, the transitions in the rate of coverage by O₃ molecules show similar tendencies to the H₂O transitions explained in FIGS. 12A and 12B.

From the results shown in FIGS. 10A to 15B, it can be understood that as the content of MnO₂ increases, the effect of adsorption by H₂O strengthens and the rate of coverage by O₃ decreases. If the rate of coverage by O₃ is low, the reaction with O₃ becomes more difficult. The inventors of this invention have assumed that one factor in the reduced reactivity of the ozone decomposing body explained in FIGS. 8A to 8C is this reduction in the rate of coverage. Based on this assumption, the content of MnO₂ in the MnO₂-rich layer 22 and that in the activated carbon-rich layer 24 were set within the ranges mentioned above in this embodiment. That is, the content of MnO₂ is set to be lower than that of activated carbon in the layer 24 (the upper layer), and the content of MnO₂ is set to be higher than that of activated carbon in the MnO₂-rich layer 22 (the lower layer). In this way, water is adsorbed on the activated carbon in the upper layer, which is in direct contact with external air, and O₃ can be reliably decomposed by the MnO₂ in the lower layer. In addition, O₃ can be decomposed mainly by the activated carbon in the upper layer, which is easily cooled through contact with external air, and O₃ can be decomposed mainly by MnO₂ in the lower layer, which is relatively warm.

The ozone decomposing layer 20 is formed on the radiator 14 in this embodiment, but the position at which the ozone decomposing layer 20 is to be formed may be an air conditioner condenser, an intercooler, or an inverter for a hybrid vehicle. These constituent parts can be fitted to the vehicle, like the radiator 14, and the constituent parts are cooled by means of cooling principles similar to the radiator 14 (a cooling medium in the case of water cooling). When using constituent parts such as these, the ozone decomposing layer 20 can be formed in the same way as in this embodiment.

What is claimed is:

1. An air purification apparatus for a vehicle, the vehicle including a vehicle component provided at a location where air flows while the vehicle is moving, the air purification apparatus comprising:
an ozone decomposing body that contains MnO₂ and activated carbon as components that decompose ozone,
the ozone decomposing body including a first layer and a second layer, the first layer being provided on a surface of the vehicle component,
a content of MnO₂ being higher than that of activated carbon in the first layer, and
a content of activated carbon being higher than that of MnO₂ in the second layer.

2. The air purification apparatus according to claim 1, wherein the content of MnO₂ in the first layer is between 50 wt % and 80 wt % inclusive, and the content of MnO₂ in the second layer is equal to or higher than 20 wt % and lower than 50 wt %.

3. The air purification apparatus according to claim 1, wherein the vehicle component is at least one of a radiator, an intercooler, or an inverter for a hybrid vehicle.
